(19) United States
(12) Patent Application Publication
(10) Pub. No.: US 2014/0355468 A1
(43) Pub. Date: Dec. 4, 2014

(54) Methods and devices for notifying interference measurement signaling, interference measurement and feedback

(71) Applicants: Yu Ngok Li, Shenzhen (CN); Yijian Chen, Shenzhen (CN); Senbao Guo, Shenzhen (CN); Hong Tang, Shenzhen (CN)

(72) Inventors: Yu Ngok Li, Shenzhen (CN); Yijian Chen, Shenzhen (CN); Senbao Guo, Shenzhen (CN); Hong Tang, Shenzhen (CN)

(73) Assignee: ZTE CORPORATION, Shenzhen, Guangdong (CN)

(21) Appl. No.: 14/348,766

(22) PCT Filed: Dec. 30, 2011
(86) PCT No.: PCT/CN2011/085049

§ 371 Date: Mar. 31, 2014

(30) Foreign Application Priority Data
Sep. 30, 2011 (CN) 201110301608.4

(51) Int. Cl. H04W 24/08; H04L 5/00; H04W 72/04

(52) U.S. Cl. CPC H04W 24/08; H04W 72/042; H04L 5/0092
USPC 370/252

(57) ABSTRACT

The present disclosure provides a method for notifying an interference measurement signalling, including that: notifying, by a network side, information of M subframes included in an interference measurement subframe set or a channel quality measurement subframe set to a terminal. The present disclosure also provides a method for measuring interference, including that: receiving, by a terminal, a notification of information of an interference measurement subframe set or a quality measurement subframe set sent by a network side, performing interference measurement on each subframe of the interference measurement subframe set or the channel quality measurement subframe set, and calculating an average interference value; and determining, by the terminal, Channel Quality Indication (CQI) information according to the average interference value, and feeding the CQI information back to a base station. The present disclosure further provides a method for feeding back channel quality information, including that: performing, by a terminal, interference measurement on one or more subframes specified by a base station, determining a CQI according to the measurement result, and feeding back the CQI to the base station. The present disclosure also provides devices for implementing above methods. In the present disclosure, the base station can accurately determine a modulation and coding scheme of the terminal according to the interference measurement result, thus improving data transmission efficiency.

### TECHNICAL FIELD

The present disclosure relates to interference measurement technology, and in particular to a method and a device for notifying an interference measurement signaling, to a method and a device for measuring interference, and to a method and device for feeding back channel quality information.

### BACKGROUND

In a Long Term Evolution (LTE) system, Channel State Information (CSI) for indicating a downlink physical channel mainly includes the following three parameters: a Channel Quality Indication (CQI), a Pre-coding Matrix Indicator (PMI) and a Rank Indicator (RI).

Specifically, the CQI is an indicator for measuring the quality of a downlink channel. In the 3GPP TS 36.213 protocol, a CQI index is indicated by integer values 0 to 15 which represent different CQI levels, respectively. And each CQI level corresponds to a respective Modulation and Coding Scheme (MCS). Therefore, there are 16 conditions which may be indicated by 4-bit information. The corresponding relation between the CQI index and the MCS is as shown in Table 1 below.

TABLE 1

| | Modulation | Code rate × | |
|---|---|---|---|
| CQI Index | Scheme | 1024 | Efficiency |
| 0 | exceeding | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16 QAM | 378 | 1.4766 |
| 8 | 16 QAM | 490 | 1.9141 |
| 9 | 16 QAM | 616 | 2.4063 |
| 10 | 64 QAM | 466 | 2.7305 |
| 11 | 64 QAM | 567 | 3.3223 |
| 12 | 64 QAM | 666 | 3.9023 |
| 13 | 64 QAM | 772 | 4.5234 |
| 14 | 64 QAM | 873 | 5.1152 |
| 15 | 64 QAM | 948 | 5.5547 |

In a LTE system, the significance for feeding back CQI lies in that a proper modulation and coding level for a transmission block may be selected by a User Equipment (UE) and recommended to a base station according to a channel quality so that the base station performs modulation and coding according to the recommended information, to maximize the transmission capability of its channels.

From another perspective, the CQI may be construed as quantization of channel quality information, if a channel has a good channel quality, it may support a high-order modulation and coding scheme and acquire higher transmission rate. If the channel has a bad channel quality, it may perform data transmission in a low-order modulation and coding scheme to ensure robustness of the transmission performance.

In the prior art, there are established algorithms for calculating RI, PMI and CQI, such as selecting the optimal RI, PMI and CQI by using a maximum capacity criterion. Generally, RI/PMI/CQI is not selected independently but selected uniformly. The accuracy of PI/PMI/CQI calculation and selection is affected by two factors: channel measurement and interference noise measurement.

Channel measurement may be implemented by measuring Common Reference Signals (CRS) or Channel State Information-Reference Signals (CSI-RS) in a LTE/LTE-A system. Currently, channels may be measured accurately by CRS or CSI-RS due to a superior reference signal design.

However, interference noise measurement is a bottleneck, and incorrect interference information may result in a mismatch between number of layers and practical channel quality state, for example, a channel can actually support only two layers, but it is misjudged that it can support four layers due to a measurement error of the interference noise information, if the above incorrect information is fed back to a base station, a very high bit error rate of the transmission data may be resulted in. Or, the channel can actually support a low-order modulation and coding scheme but it is misjudged that it can support a high-order modulation and coding scheme, and therefore a too high bit error rate may also be resulted in. Conversely, it may be possible that the channel can support multiple layers and a high-order modulation and coding scheme but actually less layers and a lower-order coding scheme are used for transmitting, thus resulting in a waste of transmission resources.

Noise measurement is relatively simple, because noise is generally resulted from a device itself. While interference is mainly from other cells or other nodes, and because the other cells or nodes may use different transmission techniques, such as different pre-codings, or have different transmitted signals, a change in interference may be resulted in. Therefore, noise measurement is the main problem currently facing.

FIG. 1 shows a schematic diagram illustrating an averaging process on interference in successive M TTIs. As shown in FIG. 1, there are various kinds of existing methods for measuring interference, and a terminal may use any one of them without being restricted by protocols. A commonly-used algorithm for measuring interference is as follows: performing an averaging process on interference in a previous M Transmission Timing Intervals (TTI), acquiring an average interference, and calculating the CQI by assuming that it is affected by the average interference when the CQI is calculated.

However, for a terminal, it is not clear whether there is data transmission in an interfering cell, the current data scheduling conditions of the interfering cell may only be determined in the case that the base station is at a centralized scheduling. FIG. 2 shows a schematic diagram of channel quality mismatching the reality during transmission. As shown in FIG. 2, if there is currently no data scheduling, but the interference measurement of the terminal is still performing statistical averaging determination, misjudgment of RI and CQI may be resulted in, the measured channel quality may mismatch the practical channel quality when transmitting data, and number of transmission layers and modulation and coding may mismatch the channel quality, resulting in great performance loss.

In existing protocols, a base station does not control interference measurement of a terminal. Therefore, the base station does not determine how many subframes the terminal uses to perform averaging process. The value of M may be any integer. Therefore, the base station cannot perform a targeted adjustment according to information reported by a UE.

### SUMMARY

In view of the above, the present disclosure provides a method and a device for notifying an interference measurement signaling, a method and a device for measuring interference, and a method and device for feeding back channel quality information, capable of solving the problem that interference information of subframes may not be accurately provided to a base station.

To this end, the technical solutions of the present disclosure are implemented as follows.

A method for notifying an interference measurement signaling includes:

a network side notifies information of M subframes included in an interference measurement subframe set or a channel quality measurement subframe set to a terminal.

Preferably, notifying the information of the interference measurement subframe set or the channel quality measurement subframe set to the terminal may include:

the network side carries the M in a high layer signaling or a physical layer signaling, and notifying the terminal.

Preferably, the physical signaling and a signaling for triggering an aperiodic Channel State Information (CSI) report may be carried in the same Format of a Physical Downlink Control Channel (PDCCH), and sent to the terminal.

Preferably, the M may be a number of successive interference measurement subframes or successive channel quality measurement subframes.

A method for measuring interference includes:

receiving, by a terminal, a notification of information of an interference measurement subframe set or a channel quality measurement subframe set sent by a network side, performing interference measurement on each subframe of the interference measurement subframe set or the channel quality measurement subframe set, and calculating an average interference value; and

determining, by the terminal, Channel Quality Indication (CQI) information according to the average interference value, and feeding the CQI information back to a base station.

Preferably, the information of the interference measurement subframe set or the channel quality measurement subframe set may be a number of interference measurement subframes or the channel quality measurement subframes.

Preferably, the interference measurement subframes or the channel quality measurement subframes may be successive M subframes.

Preferably, the method may further include:

adjusting, by the base station, a current modulation and coding scheme according to the CQI fed back by the terminal and scheduling information of a period corresponding to the interference measurement subframe set or the channel quality measurement subframe set.

Preferably, the step of adjusting, by the base station, a current modulation and coding scheme according to the CQI fed back by the terminal and scheduling information of a period corresponding to the interference measurement subframe set or the channel quality measurement subframe set may include:

adjusting, by the base station, the current modulation and coding scheme according to the CQI fed back by the terminal and a number of subframes of actual data transmissions of an interfering cell or an interfering node.

A method for feeding back channel quality information includes:

performing, by a terminal, interference measurements on one or more subframes specified by a base station, and determining a Channel Quality Indication (CQI) according to the measurement results, and feeding back the CQI to the base station.

Preferably, the method may further include:

receiving, by the terminal, a subframe offset indication sent by the base station, and determining the specified subframes as one or more subframes based on the difference between a reference subframe number of a channel measurement and a subframe offset; or

receiving, by the terminal, a subframe number and the subframe offset indication sent by the base station, and determining the specified subframes as subframes based on the difference between a reference subframe number of a channel measurement and one or more subframe offsets.

Preferably, the method may further include:

carrying, by the base station, the subframe offset indication or the subframe number and the subframe offset indication in a high layer signaling or a physical layer signaling, and notifying the terminal.

Preferably, the physical signaling and a signaling for triggering an aperiodic Channel State Information (CSI) report may be carried in the same Format of a Physical Downlink Control Channel (PDCCH), and sent to the terminal.

A method for feeding back channel quality information includes:

performing, by a terminal, a specified interfering channel measurement on a part of resource positions on a subframe specified by a base station, determining a first CQI by using the measurement result and measurement results of other interference and noise, and feeding back the first CQI to the base station; and

eliminating, by the terminal, interference on a specified interfering channel, determining a second CQI by only considering measurement results of interference and noise from other interfering channels, and feeding back the second CQI to the base station.

Preferably, performing, by the terminal, measurement on an interfering channel specified by a base station may include:

performing, by the terminal, interference measurement on the interfering channel by using reference signal positions on one or more subframes including CRI-RS or zero power CRI-RS of a specific frame or prior to the specific frame, and measuring interference of other interfering channels when the interference of the specified interfering channel is zero, wherein the specific frame is a reference subframe for a channel measurement.

A device for notifying an interference measurement signaling includes:

a notification unit configured to notify information of M subframes included in an interference measurement subframe set or a channel quality measurement subframe set to a terminal.

Preferably, the notification unit may be further configured to carry the information of M subframes included in the interference measurement subframe set or the channel quality measurement subframe set in a high layer signaling or a physical layer signaling and to notify the terminal.

A device for measuring interference includes a receiving unit, a measurement and calculation unit and a feedback unit, wherein

the receiving unit is configured to receive a notification of information of M subframes included in an interference measurement subframe set or a channel quality measurement subframe set sent by a network side;

the measurement and calculation unit is configured to perform interference measurement on each of the M subframes and to calculate an average interference value; and

the feedback unit is configured to determine CQI information and to feed back the CQI information to a base station.

Preferably, the device may further include:

an adjustment unit, located in a base station, configured to adjust a current modulation and coding scheme according to the CQI fed back by the feedback unit and scheduling information of a period corresponding to the interference measurement subframe set or the channel quality measurement subframe set.

A device for feeding back channel quality information includes a measurement unit, a first determination unit and a feedback unit, wherein

the measurement unit is configure to perform interference measurement on a subframe specified by a base station;

the first determination unit is configured to determine a Channel Quality Indication (CQI) according to the measurement result of the measurement unit; and

the feedback unit is configured to feed back the CQI to the base station.

Preferably, the device may further include a receiving unit and a second determination unit, wherein

the receiving unit is configured to receive a subframe offset indication or a subframe number and the subframe offset indication sent by the base station;

the second determination unit is configured to determine the specified subframe as a subframe based on the difference between a current subframe number and a subframe offset according to the subframe offset indication sent by the base station and received by the receiving unit; or

the second determination unit is configured to determine the specified subframe as a subframe based on the difference between the subframe number and a subframe offset according to the subframe number and the subframe offset indication sent by the base station and received by the receiving unit.

A device for feeding back channel quality information includes a measurement unit, a determination unit and a feedback unit, wherein

the measurement unit is configured to perform a specified interfering channel measurement on a part of resource positions on a subframe specified by a base station; and, to eliminate interference on the specified interfering channel and to measure interference from other interfering channels;

the determination unit is configured to determine a first Channel Quality Indication (CQI) according to the measurement result of the interfering channel measurement on a part of resource positions on a specified subframe and measurement results of other interference and noise; to eliminate interference on the specified interfering channel and to determine a second CQI according to measurement results of interference and noise from other interfering channels; and

the feedback unit is configured to feed back the first CQI and the second CQI to the base station.

Preferably, the measurement unit may be further configured to perform interference measurement on an interfering channel by using reference signal positions on one or more subframes including CRI-RS or power zero CRI-RS of a specific frame or prior to the specific frame, and to measure interference of other interfering channels when the interference of the specified interfering channel is zero, wherein the specific frame is a subframe corresponding to a time when the base station triggered measurement signaling is transmitted.

In the present disclosure, a base station notifies CSI information to be measured to a terminal, the terminal performs interference measurement according to an instruction of the base station, and feeds back the measurement result to the base station in time, accordingly, the base station can accurately determine a modulation and coding scheme of the terminal according to the interference measurement result, thus improving data transmission efficiency.

### BRIEF DESCRIPTION OF THE DRAWINGS

FIG. 1 shows a schematic diagram illustrating an averaging process on interference in successive M TTIs;

FIG. 2 shows a schematic diagram of channel quality mismatching the reality during transmission;

FIG. 3 shows a structure diagram of a device for notifying an interference measurement signaling according to an embodiment of the present disclosure;

FIG. 4 shows a structure diagram of a device for measuring interference according to an embodiment of the present disclosure;

FIG. 5 shows a structure diagram of a device for feeding back channel quality information according to an embodiment of the present disclosure; and

FIG. 6 shows another structure diagram of a device for feeding back channel quality information according to an embodiment of the present disclosure.

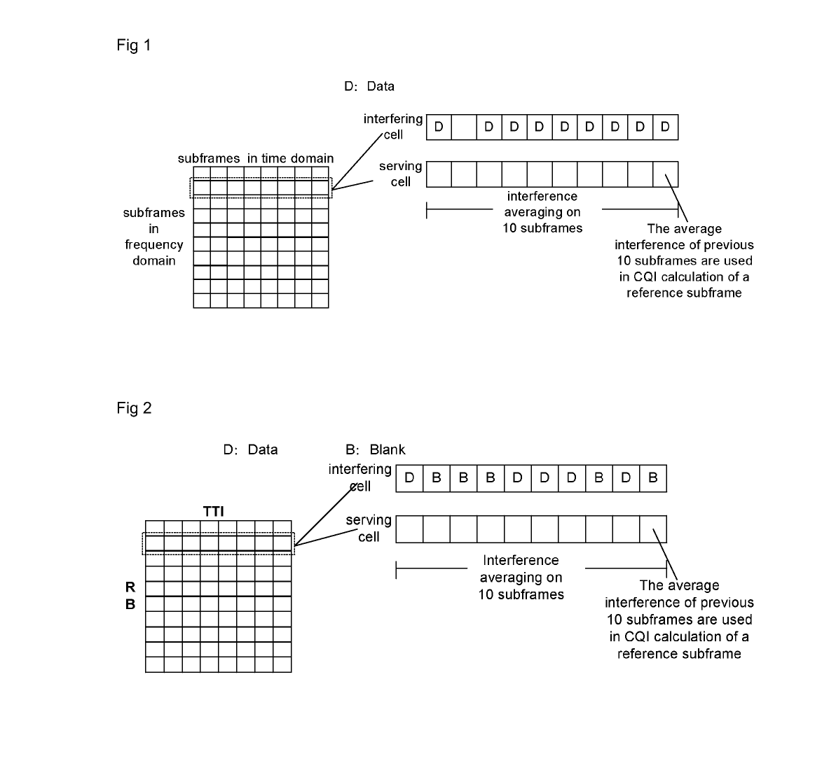

### DETAILED DESCRIPTION

A base station notifies CSI information to be measured to a terminal, the terminal performs interference measurement according to an instruction of the base station, and feeds back the measurement result to the base station in time. Accordingly, the base station can accurately determine a modulation and coding scheme of the terminal according to the interference measurement result, thus improving data transmission efficiency.

In order to make the objects, technical solutions and advantages of the present disclosure better understood, the present disclosure will be further explained in detail below by illustrating embodiments with reference to the drawings.

### First Embodiment

This embodiment describes how a base station uses a signaling to notify information of M successive subframes included in an interference measurement subframe set or a channel quality measurement subframe set to a UE.

As shown in Table 2 below, eight M values can be indicated by 3 status bits.

TABLE 2

| | |
|---|---|
| 000 | 1 subframe |
| 001 | 5 subframes |
| 010 | 10 subframes |
| 011 | 20 subframes |
| 100 | 40 subframes |
| 101 | 80 subframes |
| 110 | 160 subframes |
| 111 | 320 subframes |

As shown in Table 3, four M values can be indicated by 2 status bits.

TABLE 3

| | |
|---|---|
| 00 | 1 subframe |
| 01 | 10 subframes |
| 10 | 100 subframes |
| 11 | 1000 subframes |

In the present disclosure, the method for indicating M successive subframes included in an interference measurement subframe set or a channel quality measurement subframe set are not limited to those shown in Table 2 and Table 3. Number of bits indicating M values is not limited to 2 or 3, and can be set as required.

Once the corresponding relations in Table 2 and Table 3 are determined, they will be notified to a terminal or configured in the terminal beforehand.

### Second Embodiment

This embodiment describes the following two conditions: a signaling carrying the information of the above M successive subframes is transmitted in a Radio Resource Control (RRC) layer or in a physical layer.

A RRC signaling belongs to a high layer signaling, a base station may carry the 2-bit or 3-bit information described in the first embodiment and other bit information indicating an M value in a RRC layer signaling, and notify these information to a UE. The RRC layer signaling may be maintained for a long time after coming into effect, the M successive subframes included in an interference measurement subframe set or a channel quality measurement subframe set will be determined according to the M information previously notified before the RRC signaling is changed.

A base station may also notify the M information to a UE by a physical layer signaling. For example, the M information together with a triggered signaling for triggering an aperiodic CSI feedback are carried in a Downlink Control Information (DCI) Format 0 or a DCI Format 4 defined by a LTE/LTE-A protocol.

M information binded together with triggered information of an aperiodic CSI feedback are transmitted. In addition, the M information is valid only for the aperiodic CSI feedback currently triggered.

For example, a base station triggers an aperiodic CSI feedback, and needs to report the CQI and to notify that M=10. For the current RI/PMI/CQI calculation, the UE determines an interference measurement subframe set according to M=10, measures an average interference, and the average interference information is applied to the RI/PMI/CQI calculation of the current feedback.

### Third Embodiment

This embodiment describes a method for measuring interference of a UE.

A terminal acquires M information by receiving a high layer signaling or a physical layer signaling, further determining M successive subframes included in an interference measurement subframe set or a channel quality measurement subframe set.

A terminal may perform interference measurement according to Common Reference Resource (CRS), i.e., the interference on the measured CRS may be acquired by subtracting the evaluated reference signal signal from the received signal on the CRS. Taking M=10 as an example, it is assumed that interference of 10 subframes are I1, I2 . . . I10 respectively, the UE may assume that interference of the subframes currently measured is arithmetic average interference: I=(I1+I2+ . . . +I10)/10

It may also be weighted average interference, such as I=(a1×I1+a2×I2+ . . . +a10×I10)/(a1+a2+ . . . +a10).

A terminal may perform interference measurement according to a CSI-RS (a channel quality measurement reference signal defined in the LTE protocol), and an interfering channel H is measured by the CSI-RS. M=1 is taken as an example and illustrated as below.

An interfering channel H from an interfering cell to a terminal is measured by the terminal, and interference calculation is performed according to the interfering channel H, an assumed interference and coding vector.

For example, it is assumed that the interference and coding vector is w, which is a codeword of a codebook defined in LTE, then a correlation matrix Rnn of the interference is acquired as Hw×w′H′, wherein ′ stands for conjugate transpose. It is also possible that correlation matrix Rnn=(Hw1×w1′H′+Hw2×w2′H′+ . . . +Hwn×wn′H′)/n, wherein w1, w2 . . . wn are codewords of a codebook defined in LTE, and the codeword is different from each other.

Alternatively, a terminal may perform interference measurement on one or more subframes specified by a base station, determine a CQI according to the measurement result and feed back the CQI to the base station. The measurement method and feeding back method are the same as those described above.

Specifically, the base station carries the subframe offset indication or the subframe number and the subframe offset indication in a high layer signaling or a physical layer signaling, and notifies them to the terminal. The physical signaling and a signaling for triggering an aperiodic Channel State Information (CSI) report are carried in the same Format of a Physical Downlink Control Channel (PDCCH), and sent to the terminal.

The terminal receives the subframe number and the subframe offset indication sent by the base station, and determines the specified subframes as one or more subframes corresponding to the difference between a reference subframe number of a channel measurement and a subframe offset.

Alternatively, the terminal receives the subframe number and the subframe offset indication sent by the base station, and determines the specified subframes as subframes corresponding to the difference between a reference subframe number of a channel measurement and one or more subframe offsets.

### Fourth Embodiment

A base station may adjust CSI according to received measurement result, and mainly adjusts a CQI. The CQI is taken as an example and illustrated as below.

The CQI fed back by a UE stands for a modulation and coding scheme of a transmission, and is also regarded as Signal to Interference plus Noise Ratio (SINR) information. SINR1=S/(I+N), wherein S is signal information, N is noise power and other interference, and I is adjacent cell interference information.

Taking the case as an example, where M, the number of successive subframes included in a subframe set, is 10 and adjacent cell interference exists in 5 subframes out of the 10 previously scheduled subframes, the base station considers that the calculation of SINR1 fed back by a terminal performs averaging on 10 subframes, while the base station determines according to its own scheduling information that 5 subframes out of the 10 subframes are not affected by adjacent cell interference. Accordingly, if adjacent cell interference exists in subframes to be scheduled currently, the base station determines that the adjacent interference (I) value used when the SINR1 is calculated and reported by a UE tends to be smaller. Therefore, the base station needs to adjust SINR2 of subframes to be adjusted where adjacent interference currently exist in based on the SNR1, specifically, SINR2=S/(2I+N). Here, the base station is required to acquire ratio information between I and N to determine the I value to be adjusted and thus adjust SINR of the subframes to be scheduled currently, wherein the ratio information may be evaluated by the base station or reported by the UE.

If there is no interference in subframes to be scheduled, the base station determines that the adjacent interference (I) value used when the SINR1 is calculated and reported by a UE tends to be greater. Therefore, the base station needs to adjust SINR3 of subframes to be scheduled currently, specifically, SINR3=S/N. Here, the base station requires to acquire ratio information between I and N to adjust SINR3, wherein the ratio information may be evaluated through multiple measurement and calculation by the base station or reported by the UE.

### Fifth Embodiment

This embodiment mainly describes a method for feeding back channel quality information. The example mainly includes: performing, by the terminal, interference measurement on the specified interfering channel by using one or more subframes including CRI-RS or zero power CRI-RS of a specific frame or prior to the specific frame, measuring interference of other interfering channels when the interference of the specified interfering channel is zero, and feeding back the two measurement results to the base station.

A base station triggers an aperiodic CSI feedback by a signaling, and specifies a UE to measure channel information on a subframe n and to measure first cell interference information on all or a part of resource positions of the subframe n or one or more subframes prior to n. The subframe n is a subframe corresponding to a time when a base station triggered signaling is transmitted.

A base station may determine subframes to be measured previously by the subframe n and the corresponding offset. For example, when offset information is carried by the subframe n, it is determined by a terminal that interference measurement of specified interfering channels will be performed on subframes corresponding to n minus the offset (when there are multiple specified subframes, the base station will notify multiple offsets, which are non-negative integer values). The subframes specified by the base station are all subframes including CSI-RS or zero power CSI-RS.

However, when the base station does not specify subframes to be measured, the terminal will perform interference measurement of specified interfering channels on reference signal positions of subframes including CSI-RS or zero power CSI-RS of the subframe n and subframes prior to n, then first interference measurement result is acquired, and a first CSI for quantifying CSI information is calculated according to the channel measurement result, the first interference measurement result, interference measurement results of other interfering channels, noise and the like.

In the present disclosure, the CSI information includes one or more parameters of RI, PMI and CQI.

Wherein zero CSI-RS are vacant positions in a cell, these positions are for other calls (interfering cell) to transmit reference signal, accordingly, interference information of other cells may be measured on these positions.

In this example, the terminal further measures interference of other interfering channels of other interfering sources besides the interfering channels specified by the base station. A second CSI for quantifying CSI information is calculated by only considering the interference measurement result and noise of other interfering channels combined with the specified channel measurement result.

The terminal will feed back the calculated first CSI and the second CSI on data channels of the specified uplink subframes.

A base station may determine the effect of the interference of the specified interfering channels and the interference of other interfering channels on interference of a terminal serving cell, so as to determine whether some interfering sources should be closed to ensure service quality of the terminal serving cell.

### Sixth Embodiment

This embodiment mainly describes a method for feeding back channel quality information.

A base station triggers an aperiodic CSI feedback by a signaling, and carries the triggered information in a DCI Format, and specifies a UE to measure channel information on a subframe n according to the position of the DCI Format and pre-defined regulations.

Moreover, the base station notifies the UE to measure interference of specified subframes m_1, m_2, . . . , m_p respectively, specifically, to measure information of first interference, second interference, . . . , pth interference of resource sets REset_1, REset_2, . . . , REset_p on all or a part of resource positions of the subframes m_1, m_2, . . . , m_p. Wherein the subframe n is determined according to a time for transmitting a base station triggered signaling.

The subframes m_1, m_2, . . . , m_p may be determined, by the base station, by specifying offsets between the subframe n and a subframe m through a signaling, such as m_1=n-offset_1, m_2=n-offset_2, . . . , m_p=n-offset_p, wherein offset_1, offset_2, . . . , offset_p are non-negative integers.

CSI information for quantifying is calculated according to the information of the first interference, the second interference, . . . , the pth interference of respective specified subframes and the noise of respective specified subframes above, and is notified to the base station.

The base station may select conditions with the same CSI of the specified subframes aforementioned according to the interference conditions of the subframes to be scheduled currently, thus determining a modulation and coding scheme of a terminal.

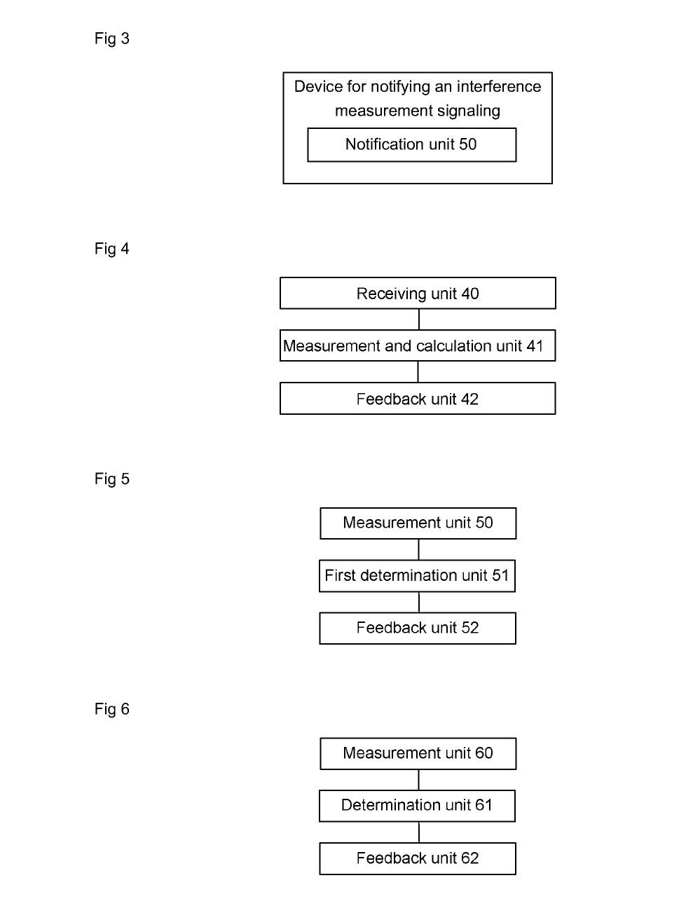

FIG. 3 shows a structure diagram of a device for notifying an interference measurement signaling according to embodiments of the present disclosure. As shown in FIG. 3, the device for notifying an interference measurement signaling according to embodiments of the present disclosure includes:

a notification unit 30 configured to notify information of M subframes included in an interference measurement subframe set or a channel quality measurement subframe set to a terminal.

The notification unit 30 is further configured to carry the M in a high layer signaling or a physical layer signaling and to notify the terminal.

The physical signaling and a signaling for triggering an aperiodic Channel State Information (CSI) report are carried in the same Format of a Physical Downlink Control Channel (PDCCH), and sent to the terminal.

It should be appreciated by those skilled in the art that the device for notifying an interference measurement signaling shown in FIG. 3 is designed for implementing the aforementioned method for notifying an interference measurement signaling, functions of the notification unit 30 in the device for notifying an interference measurement signaling shown in FIG. 3 can be understood with reference to the description of the aforementioned method, and the functions of the processing unit can be implemented by programs operated on a processor, or can also be implemented by a specific logic circuit.

FIG. 4 shows a structure diagram of a device for measuring interference according to embodiments of the present disclosure. As shown in FIG. 4, the device for measuring interference according to embodiments of the present disclosure includes a receiving unit 40, a measurement and calculation unit 41 and a feedback unit 42, wherein the receiving unit 40 is configured to receive a notification of information of M subframes included in an interference measurement subframe set or a channel quality measurement subframe set sent by a network side;

the measurement and calculation unit 41 is configured to perform interference measurement on each of the M subframes and to calculate an average interference value; and

the feedback unit 42 is configured to determine CQI information and to feed back to a base station.

Based on the device for measuring interference shown in FIG. 4, the device for measuring interference according to embodiment of the present disclosure further includes:

an adjustment unit (not shown in FIG. 4), located in a base station, configured to adjust a current modulation and coding scheme according to the CQI fed back by the feedback unit and scheduling information in a period of time corresponding to the interference measurement subframe set or the channel quality measurement subframe set.

It should be appreciated by those skilled in the art that the device for measuring interference shown in FIG. 4 is designed for implementing the aforementioned method for measuring interference, functions of each unit in the device for measuring interference shown in FIG. 4 can be understood with reference to the description of the aforementioned method, and the functions of each processing unit can be implemented by programs operated on a processor, or can also be implemented by a specific logic circuit.

FIG. 5 shows a structure diagram of a device for feeding back channel quality information according to embodiments of the present disclosure. As shown in FIG. 5, the device for feeding back channel quality information according to embodiments of the present disclosure includes a measurement unit 50, a first determination unit 51 and a feedback unit 52, wherein

the measurement unit 50 is configured to perform interference measurement on a subframe specified by a base station;

the first determination unit 51 is configured to determine a CQI according to the measurement result of the measurement unit; and

the feedback unit 52 is configured to feed back the CQI to the base station.

Based on the device for feeding back channel quality information shown in FIG. 5, the device for feeding back channel quality information according to embodiments of the present disclosure further includes a receiving unit (not shown in FIG. 5) and a second determination unit (not shown in FIG. 5), wherein

the receiving unit is configured to receive a subframe offset indication or a subframe number and the subframe offset indication sent by the base station;

the second determination unit is configured to determine the specified subframe as a subframe corresponding to the difference between a current subframe number and a subframe offset according to the subframe offset indication sent by the base station and received by the receiving unit; or

the second determination unit is configured to determine the specified subframe as a subframe corresponding to the difference between the subframe number and a subframe offset according to the subframe number and the subframe offset indication sent by the base station and received by the receiving unit.

It should be appreciated by those skilled in the art that the device for feeding back channel quality information shown in FIG. 5 is designed for implementing the aforementioned method for feeding back channel quality information, functions of each processing unit in the device for feeding back channel quality information shown in FIG. 5 can be understood with reference to the description of the aforementioned sixth embodiment, and the functions of each processing unit can be implemented by programs operated on a processor, or can also be implemented by a specific logic circuit.

FIG. 6 shows another structure diagram of a device for feeding back channel quality information according to embodiments of the present disclosure. As shown in FIG. 6, the device for feeding back channel quality information according to embodiments of the present disclosure includes a measurement unit 60, a determination unit 61 and a feedback unit 62, wherein

the measurement unit 60 is configured to perform a specified interfering channel measurement on a part of resource positions on a subframe specified by a base station; and, to eliminate interference on the specified interfering channel and to measure interference from other interfering channels;

the determination unit 61 is configured to determine a first CQI according to the measurement result of the interfering channel measurement on a part of resource positions on a specified subframe and measurement results of other interference and noise; to eliminate interference on the specified interfering channel and to determine a second CQI according to measurement results of interference and noise from other interfering channels; and

the feedback unit 62 is configured to feed back the first CQI and the second CQI to the base station.

The measurement unit 60 is further configured to perform interference measurement on an interfering channel by using reference signal positions on one or more subframes including CRI-RS or zero power CRI-RS of a specific frame or prior to the specific frame, and to measure interference of other interfering channels when the interference of the specified interfering channel is zero, wherein the specific frame is a subframe corresponding to a time when the base station triggered measurement signaling is transmitted.

It should be appreciated by those skilled in the art that the device for feeding back channel quality information shown in FIG. 6 is designed for implementing the aforementioned method for feeding back channel quality information, functions of each processing unit in the device for feeding back channel quality information shown in FIG. 6 can be understood with reference to the description of the aforementioned fifth embodiment, and the functions of each processing unit can be implemented by programs operated on a processor, or can also be implemented by a specific logic circuit.

The above descriptions are merely the preferred embodiments of the present disclosure, and are not intended to limit the scope of protection of the claims of the present disclosure.

1. A method for notifying an interference measurement signaling, characterized in that the method comprises:
notifying, by a network side, information of M subframes included in an interference measurement subframe set or a channel quality measurement subframe set to a terminal.

2. The method according to claim 1, wherein the step of notifying information of M subframes included in an interference measurement subframe set or a channel quality measurement subframe set to a terminal comprises:
carrying, by the network side, the M in a high layer signaling or a physical layer signaling, and notifying the terminal.

3. The method according to claim 2, wherein the physical signaling and a signaling for triggering an aperiodic Channel State Information (CSI) report are carried in the same Format of a Physical Downlink Control Channel (PDCCH), and sent to the terminal.

4. The method according to claim 1, wherein the M is a number of successive interference measurement subframes or successive channel quality measurement subframes.

5. A method for measuring interference, characterized in that the method comprises:
receiving, by a terminal, a notification of information of an interference measurement subframe set or a channel quality measurement subframe set sent by a network side;
performing interference measurement on each subframe of the interference measurement subframe set or the channel quality measurement subframe set, and calculating an average interference value; and
determining, by the terminal, Channel Quality Indication (CQI) information according to the average interference value, and feeding the CQI information back to a base station.

6. The method according to claim 5, wherein the information of the interference measurement subframe set or the channel quality measurement subframe set is a number of interference measurement subframes or channel quality measurement subframes.

7. The method according to claim 6, the interference measurement subframes or the channel quality measurement subframes are successive M subframes.

8. The method according to claim 5, further comprising:
adjusting, by the base station, a current modulation and coding scheme according to the CQI fed back by the terminal and scheduling information of a period corresponding to the interference measurement subframe set or the channel quality measurement subframe set.

9. The method according to claim 8, the step of adjusting, by the base station, a current modulation and coding scheme according to the CQI fed back by the terminal and scheduling information of a period corresponding to the interference measurement subframe set or the channel quality measurement subframe set comprises:
adjusting, by the base station, the current modulation and coding scheme according to the CQI fed back by the terminal and a number of subframes of actual data transmissions of an interfering cell or an interfering node.

10. A method for feeding back channel quality information, characterized in that the method comprises:
performing, by a terminal, interference measurements on one or more subframes specified by a base station, and determining a Channel Quality Indication (CQI) according to the measurement results, and feeding back the CQI to the base station.

11. The method according to claim 10, further comprising:
receiving, by the terminal, a subframe offset indication sent by the base station, and determining the specified subframes as one or more subframes based on the difference between a reference subframe number of a channel measurement and a subframe offset; or
receiving, by the terminal, a subframe number and the subframe offset indication sent by the base station, and determining the specified subframes as subframes based on the difference between a reference subframe number of a channel measurement and one or more subframe offsets.

12. The method according to claim 11, further comprising:
carrying, by the base station, the subframe offset indication or the subframe number and the subframe offset indication in a high layer signaling or a physical layer signaling, and notifying the terminal.

13. The method according to claim 12, wherein the physical signaling and a signaling for triggering an aperiodic Channel State Information (CSI) report are carried in the same Format of a Physical Downlink Control Channel (PDCCH), and sent to the terminal.

14. A method for feeding back channel quality information, characterized in that the method further comprises:
performing, by a terminal, a specified interfering channel measurement on a part of resource positions on a subframe specified by a base station, determining a first CQI by using the measurement result and measurement results of other interference and noise, and feeding back the first CQI to the base station; and
eliminating, by the terminal, interference on a specified interfering channel, determining a second CQI by only considering measurement results of interference and noise from other interfering channels, and feeding back the second CQI to the base station.

15. The method according to claim 14, the step of performing, by the terminal, measurement on an interfering channel specified by a base station comprises:
performing, by the terminal, interference measurement on the interfering channel by using reference signal positions on one or more subframes including CRI-RS or zero power CRI-RS of a specific frame or prior to the specific frame, and measuring interference of other interfering channels when the interference of the specified interfering channel is zero, wherein the specific frame is a reference subframe for a channel measurement.

16. A device for notifying an interference measurement signaling, characterized in that the device comprises:
a notification unit configured to notify information of M subframes included in an interference measurement subframe set or a channel quality measurement subframe set to a terminal.

17. The device according to claim 16, wherein the notification unit is further configured to carry the information of M subframes included in the interference measurement subframe set or the channel quality measurement subframe set in a high layer signaling or a physical layer signaling and to notify the terminal.

18. A device for measuring interference, characterized in that the device comprises a receiving unit, a measurement and calculation unit and a feedback unit, wherein
the receiving unit is configured to receive a notification of information of M subframes included in an interference measurement subframe set or a channel quality measurement subframe set sent by a network side;
the measurement and calculation unit is configured to perform interference measurement on each of the M subframes and to calculate an average interference value; and
the feedback unit is configured to determine CQI information and to feed back the CQI information to a base station.

19. The device according to claim 18, characterized in that the device further comprises:
an adjustment unit, located in a base station, configured to adjust a current modulation and coding scheme according to the CQI fed back by the feedback unit and scheduling information of a period corresponding to the interference measurement subframe set or the channel quality measurement subframe set.

20. A device for feeding back channel quality information, characterized in that the device comprises a measurement unit, a first determination unit and a feedback unit, wherein
the measurement unit is configure to perform interference measurement on a subframe specified by a base station;
the first determination unit is configured to determine a Channel Quality Indication (CQI) according to the measurement result of the measurement unit; and
the feedback unit is configured to feed back the CQI to the base station.

21. The device according to claim 20, characterized in that the device further comprises a receiving unit and a second determination unit, wherein
the receiving unit is configured to receive a subframe offset indication, or a subframe number and the subframe offset indication sent by the base station;
the second determination unit is configured to determine the specified subframe as a subframe corresponding to a difference between a current subframe number and a subframe offset according to the subframe offset indication sent by the base station and received by the receiving unit; or
the second determination unit is configured to determine the specified subframe as a subframe corresponding to a difference between the subframe number and a subframe offset according to the subframe number and the subframe offset indication sent by the base station and received by the receiving unit.

22. A device for feeding back channel quality information, characterized in that the device comprises a measurement unit, a determination unit and a feedback unit, wherein
the measurement unit is configured to perform a specified interfering channel measurement on a part of resource positions on a subframe specified by a base station;
and, to eliminate interference on the specified interfering channel and to measure interference from other interfering channels;
the determination unit is configured to determine a first Channel Quality Indication (CQI) according to the measurement result of the interfering channel measurement on a part of resource positions on a specified subframe and measurement results of other interference and noise; to eliminate interference on the specified interfering channel and to determine a second CQI according to measurement results of interference and noise from other interfering channels; and
the feedback unit is configured to feed back the first CQI and the second CQI to the base station.

23. The device according to claim 22, wherein the measurement unit is further configured to perform interference measurement on an interfering channel by using reference signal positions on one or more subframes including CRI-RS or zero power CRI-RS of a specific frame or prior to the specific frame, and to measure interference of other interfering channels when the interference of the specified interfering channel is zero, wherein the specific frame is a subframe corresponding to a time when the base station triggered measurement signaling is transmitted.

24. The method according to claim 2, wherein the M is a number of successive interference measurement subframes or successive channel quality measurement subframes.

25. The method according to claim 3, wherein the M is a number of successive interference measurement subframes or successive channel quality measurement subframes.

26. The method according to claim 6, further comprising:
adjusting, by the base station, a current modulation and coding scheme according to the CQI fed back by the terminal and scheduling information of a period corresponding to the interference measurement subframe set or the channel quality measurement subframe set.

27. The method according to claim 7, further comprising:
adjusting, by the base station, a current modulation and coding scheme according to the CQI fed back by the terminal and scheduling information of a period corresponding to the interference measurement subframe set or the channel quality measurement subframe set.

28. The method according to claim 26, the step of adjusting, by the base station, a current modulation and coding scheme according to the CQI fed back by the terminal and scheduling information of a period corresponding to the interference measurement subframe set or the channel quality measurement subframe set comprises:
adjusting, by the base station, the current modulation and coding scheme according to the CQI fed back by the terminal and a number of subframes of actual data transmissions of an interfering cell or an interfering node.

29. The method according to claim 27, the step of adjusting, by the base station, a current modulation and coding scheme according to the CQI fed back by the terminal and scheduling information of a period corresponding to the interference measurement subframe set or the channel quality measurement subframe set comprises:
adjusting, by the base station, the current modulation and coding scheme according to the CQI fed back by the terminal and a number of subframes of actual data transmissions of an interfering cell or an interfering node.
